(19) United States
(12) Patent Application Publication
(10) Pub. No.: US 2026/0280645 A1
(43) Pub. Date: Sep. 17, 2026

(54) QUANTIZATION IN NR LPP

(71) Applicant: Nokia Technologies Oy, Espoo (FI)

(72) Inventors: Oana-Elena BARBU, Aalborg (DK); Sajad REZAIE, Aalborg (DK); Dick CARRILLO MELGAREJO, Lappeenranta (FI)

(21) Appl. No.: 19/470,997

(22) PCT Filed: Feb. 29, 2024
(86) PCT No.: PCT/EP2024/055242

§ 371 Date: Sep. 30, 2025

(30) Foreign Application Priority Data
Apr. 4, 2023 (FI) 20235379

(51) Int. Cl. H04B 7/06

(52) U.S. Cl. CPC H04B 7/0626; H04B 7/0658

(57) ABSTRACT

Inter-alia, a method is disclosed comprising: obtaining at least one parameter set; comparing a first channel type information with a second channel type information; and based on the comparing and if the first channel type information mismatches the second channel type information, providing feedback information, or based on the comparing and if the first channel type information matches the second channel type information, applying a quantization strategy information for a quantization of one or more signals. It is further disclosed an according apparatus, computer program and system.

### FIELD

The following disclosure relates to the field of positioning, or more particularly relates to systems, apparatuses, and methods for a quantization strategy to reduce overhead and latency in LTE positioning protocol (LPP) positioning.

### BACKGROUND

In LPP positioning, positioning reports may comprise a massive number of samples/entries. Without quantization, sending such reports over the New Radio (NR) air interface may create significant overhead and latency. Quantizing these entries and/or exploiting the propagation channel properties in quantizing these entries may be beneficial.

### Summary of Some Exemplary Embodiments

The inventors realized it might be useful to enable a solution that provides a possibility to quantize positioning reports within a deployed positioning session between a network device and a user device.

According to a first exemplary aspect, a method is disclosed, the method comprising:
obtaining at least one parameter set indicative of at least a quantization strategy information and a first channel type information;
comparing the first channel type information with a second channel type information obtained by the apparatus; and
based on the comparing and if the first channel type information mismatches the second channel type information, providing feedback information, or
based on the comparing and if the first channel type information matches the second channel type information, applying the quantization strategy information for a quantization of one or more signals.

This method may for instance be performed and/or controlled by an apparatus, for instance a user device (e.g. user equipment, terminal, electronic device, Internet-of-Things (IoT) device, Industrial IoT (IIoT) device, to name but a few non-limiting examples. For instance, the method may be performed and/or controlled by using at least one processor of such a user device.

Such a user device may be configured to communicate in a mobile communication network, e.g. according to a New Radio (NR) or 5G system (5GS) or part thereof or any other mobile communications system defined by a past or future standard, in particular successors of the present 3GPP standards.

According to a second exemplary aspect, a method is disclosed, the method comprising:
selecting a quantization strategy for a quantization of one or more signals, wherein the quantization strategy is selected based, at least in part, on first channel type information;
determining at least one parameter set indicative of at least quantization strategy information and the first channel type information based on the selected quantization strategy; and
providing the at least one parameter set.

This method may for instance be performed and/or controlled by an apparatus, for instance a network device (e.g. a Location Management Function (LMF) of a mobile communication network, or a location server of the mobile communication network). For instance, the network device may be, comprise, or be part of a base station of a communication network of any generation (e.g. a gNB, eNodeB, NodeB, BTS or the like) of 3GPP standard. Alternatively, this method may be performed and/or controlled by more than one apparatus, for instance a server cloud comprising at least two servers. For instance, the method may be performed and/or controlled by using at least one processor of the network device.

Multiple network entities of the exemplary aspects (e.g. user device(s), and/or network device(s) as disclosed above) may in particular establish a communication system or network of above. The network device of the exemplary aspects may be capable of being in direct and/or indirect communication with the exemplary apparatus of the first aspect, and vice versa.

According to a further exemplary aspect, a computer program is disclosed, the computer program when executed by a processor causing an apparatus, for instance a server, to perform and/or control the actions of the method according to the first and/or second exemplary aspect.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

According to a further exemplary aspect, an apparatus is disclosed, configured to perform and/or control or comprising respective means for performing and/or controlling the method according to the first and/or second exemplary aspect.

The means of the apparatus can be implemented in hardware and/or software. They may comprise for instance at least one processor for executing computer program code for performing the required functions, at least one memory storing the program code, or both. Alternatively, they could comprise for instance circuitry that is designed to implement the required functions, for instance implemented in a chipset or a chip, like an integrated circuit. In general, the means may comprise for instance one or more processing means or processors.

According to a further exemplary aspect, an apparatus is disclosed, comprising at least one processor and at least one memory including computer program code, the at least one memory and the computer program code configured to, with the at least one processor, cause an apparatus, for instance the apparatus, at least to perform and/or to control the method according to the first and/or second exemplary aspect.

The above-disclosed apparatus according to any aspect may be a module or a component for a device, for example a chip. Alternatively, the disclosed apparatus according to any aspect may be a device, for instance a server or server cloud. The disclosed apparatus according to any aspect may comprise only the disclosed components, for instance means, processor, memory, or may further comprise one or more additional components.

According to a further exemplary aspect, a system is disclosed, comprising:
one or more apparatuses according to the first aspect as disclosed above, and at least one apparatus according to the second aspect as disclosed above.

Any disclosure herein relating to any exemplary aspect is to be understood to be equally disclosed with respect to any subject-matter according to the respective exemplary aspect, e.g. relating to an apparatus, a method, a computer program, and a computer-readable medium. Thus, for instance, the disclosure of a method step shall also be considered as a disclosure of means for performing and/or configured to perform the respective method step. Likewise, the disclosure of means for performing and/or configured to perform a method step shall also be considered as a disclosure of the method step itself. The same holds for any passage describing at least one processor; and at least one memory including computer program code; the at least one memory and the computer program code configured to, with the at least one processor, cause an apparatus at least to perform a step.

For convenience, a list of abbreviations used in the following is already given at this point:
AI Artificial Intelligence
CIR channel impulse response
DFT discrete Fourier transform
DCT discrete cosine transform
DL downlink
ML Machine Learning
NR New Radio
NW Network
LMF Location Management Function
LPP LTE positioning protocol
PRS positioning reference signal
PSS primary Synchronization Signal
RF Radio Frequency
PDP power delay profile
QC quantization codebook
TRP Transmission (Tx)/Reception (Rx) Point
UE user equipment
UL uplink
VQ vector quantization

In the following, exemplary features and exemplary embodiments of all aspects will be described in further detail.

In AI/ML positioning, RAN1 is considering standardizing the reporting of N_{TRP}*Nₚₒᵣₜ*Nₜ CIR/PDP values, where N_{TRP} is the total number of TRPs to be measured, Nₚₒᵣₜ is the number of RF chains (e.g. as comprised by or connectable to a user device of the first aspect) and Nₜ is the number of the first CIR (and/or PDP−) sample(s) in a/the delay domain. Typical values for these entries may be e.g.:
N_{TRP} in the order of tens (potentially hundreds for FR2 beamed positioning), e.g. 20-100;
Nₚₒᵣₜ ∈[1, Nₘₐₓ], Nₘₐₓ=8; and
Nₜ ∈[50, 250].

It is noted that one or more positioning reports provided for positioning (e.g. also referred to as CIR/PDP reports) and comprising the values of above, may assume that multipath component indexed k has a corresponding delay d [k]=kT, where T is the sampling time of a respective system. However, it may rarely be the case that the first Nₜ CIR components/values are all non-negligible. Otherwise put, it may rarely be the case present that the reported (non-negligible) CIR component ‘k’ is associated with a delay KT. Therefore, in addition to the N_{TRP}*Nₚₒᵣₜ*Nₜ CIR/PDP report, an associated delay vector may be beneficial. Such a delay vector may be provided (e.g. reported) so that e.g. a CIR component is fully characterized by a gain and a delay value, to name but one non-limiting example.

The NW (e.g. mobile communication network, e.g. comprising the user device and/or the network device of the first and/or second aspect) may support positioning reports of e.g. 2×100×8×250=4e5 entries. Without some sort of quantization, providing (e.g. sending) such reports over the NR air interface from the user device to the network device may yield in a large (e.g. up to unacceptable) (e.g. signaling) overhead and/or latency.

Example embodiments of the first and/or second exemplary aspect may allow to quantize such entries and/or to exploit propagation channel properties in quantizing these entries so that the quantization loss can be minimized.

The at least one parameter set is indicative of at least a quantization strategy information and a first channel type information. The at least one parameter set may comprise a plurality (e.g. at least two) of pieces of quantization strategy information and a plurality (e.g. at least two) of pieces of first channel type information.

Such a quantization strategy information, as used herewith, may be understood as information enabling e.g. the user device to quantize data/signals (e.g. above disclosed positioning reports) before a transmission, e.g. to the network device. For instance, the quantization strategy information may be indicative of or represent a scalar quantization and/or a vector quantization. Thus, the quantization strategy information may represent at least one of a scalar quantization, or a vector quantization. Additionally, the quantization strategy information may be indicative of or represent a scalar quantization of uniform or of non-uniform type, and/or a scalar quantization being a non-linear function g( ) for a non-uniform quantization scheme, to name but a few non-limiting examples. Additionally or alternatively, the quantization strategy information may be indicative of or represent a minimum and/or a maximum range of scalar quantization, a number of quantization levels (e.g. or equivalently, a number of quantization bits). Additionally, the quantization strategy information may be indicative of or represent a vector quantization comprising or represented by a QC, which may e.g. match an expected channel profile (e.g. as comprised by, indicated by or represented by the first channel type information). In case of the quantization strategy information being indicative of or representing a vector quantization, the quantization strategy information may further be indicative of or represent a dimensionality of an input to the VQ (e.g. a shape of a respective (e.g. each) codeword) across the time-spatial domain(s). The QC may be a set of indexed codewords obtained (e.g. retrieved or received by the network device and then provided to the user device) for a respective (e.g. each) type of channel profile (as comprised by, indicated by or represented by the first channel type information). The network device may determine (e.g. select) the QC. The QC may specify how consecutive CIR/PDP samples (e.g. in both Rx port and delay domain) may be quantized together.

Such a first channel type information, as used herewith, may be understood as a representation of one or more channel properties. A respective channel property of the one or more channel properties may for instance be a power delay profile, a maximum excess delay, a line-of-sight (LOS) probability, or a combination thereof, to name but a few non-limiting examples. Such a first channel type information may be a representation of one or more channel properties utilized for a communication between a respective user device of the first aspect and another network device or other network devices. Examples of such a network device or such other network devices may include other user device(s), network node(s) (such as access point(s), gNB(s) or base station(s)), or the network device of the second aspect. For instance, the first channel type information may be determined (e.g. anticipated) by the network device (e.g. LMF or location server, e.g. apparatus of the second aspect). Such a first channel type information may be indicative of a specific channel profile utilized by the user device, e.g. urban, sub-urban, hilly terrain, indoor macro/micro, to name but a few non-limiting examples.

The at least one parameter set may be obtained by the user device, e.g. by receiving the at least one parameter set from a network device of the second aspect. The at least one parameter set may be obtained directly by the user device, e.g. from the network device, or indirectly, e.g. via another entity that obtains (e.g. receives) the at least one parameter set from the network device, and then relays the at least one parameter set to the user device.

According to some example embodiments of all exemplary aspects, the at least one parameter set may be received as integral parameter set so that (e.g. all) information indicated by the at least one parameter set is indicated by the same parameter set. Thus, for example, the user device may obtain (e.g. receive) single parameter set indicating the information as described herein (e.g. quantization strategy information and first channel type information). Further, in some examples, the single parameter set may comprise said information (e.g. quantization strategy information and first channel type information).

According to some example embodiments of all exemplary aspects, the at least one parameter set may comprise two or more parameter sets. Each parameter set of the two or more parameter sets may be indicative of one or more different information. For example, first parameter set may be indicative of at least the quantization strategy information and second parameter set (different to the first parameter set) may be indicative of at least the first channel type information. Further, in some examples, the first parameter set may comprise the quantization strategy information and the second parameter set may comprise the first channel type information. Thus, it is noted that the information obtained (e.g. received) by the user device may be obtained (e.g. received) in same parameter set(s) or separate parameter sets. Therefore, obtaining (e.g. receiving), by the user device, at least one parameter set indicative of at least a quantization strategy information and a first channel type information may be understood as the user device receiving the quantization strategy information and receiving the first channel type information.

The user device may obtain the second channel type information. Such a second channel type information may be understood, as used herewith, to comprise content that corresponds to the above disclosed content for the first channel type information. Corresponding herein may mean that the first channel type information and second channel type information have similar, same or equal content. For example, first channel type information may indicate and/or comprise a first channel property parameter (e.g. represented by a respective channel property of the one or more channel properties) and the second channel type information may indicate and/or comprise a second channel property parameter that indicates the same content as the first channel property parameter. However, the first channel property parameter and the second channel property parameter may have matching or mismatching values. Similarly, there may be further channel property parameter(s) in the first channel type information and in the second channel type information. However, first channel type information and second channel type information may not need to have identical content as long as their respective channel (e.g. type) property or properties may be comparable with each other (e.g. same parameter, but with same or different values).

In contrast to the first channel type information, the second channel type information may be obtained by the user device outside of the at least one parameter set, e.g. by determining or estimating the second channel type information by the user device of the first aspect (e.g. itself). The user device may compare the first channel type information of the at least one parameter set to the second channel type information. As a result of such a comparing, the first channel type information may either match the second type information, or there may be a mismatch between the first channel type information and the second channel type information.

Using the example above, comparing the first channel type information with the second channel type information may be referred to as comparing a parameter pair, wherein at least one parameter of the first channel type information is compared to at least one parameter of the second channel type information. Comparing such may be based on such at least one parameter pair (more than one parameter pair may be used). Using the example above with the compared at least one parameter pair, mismatch may be determined if the user device determines that the first channel property parameter (e.g. as comprised by the first channel type information) and the second channel property parameter (e.g. as comprised by the second channel type information) have different values. On the other hand, match may be determined if the user device determines that such a first channel property parameter and such a second channel property parameter have same values. Different threshold(s) may be applied in determining whether or not the value is the same or not. That is, the values may not need to be exactly the same to have a match as long as they are within certain offset from each other.

If more than one parameter pair is used in the comparison, the user device may determine the mismatch or match based on various different logics. As one example, match may be determined if compared values of (e.g. all) channel property parameters of the first and second channel type information respectively match, and mismatch may be determined if a respective value of at least one channel property parameter of the first channel type information does not match with the (e.g. corresponding) value of corresponding channel property parameter of the second channel type information.

Example embodiments of the first exemplary aspect may comprise:
determining, based on the comparing, that the first channel type information mismatches the second channel type information; and
based on the determining, providing feedback information (e.g. to the network device).

Additionally or alternatively, example embodiments of the first exemplary aspect may comprise:
determining, based on the comparing, that the first channel type information matches the second channel type information; and
based on the determining, applying the quantization strategy information for a quantization of one or more signals.

Applying the quantization strategy information for a quantization of one or more signals may be understood as a quantizing of the one or more signals according to the quantization strategy information. Such one or more signals may for instance be or be represented by one or more PRSs. Such one or more signals may for instance not be or be represented by the one or more components of such one or more signals.

Thus, based on the comparing and if the first channel type information mismatches the second channel type information, the user device may provide (e.g. send) feedback information, e.g. to the network device (e.g. from whom the user device has obtained the at least one parameter set). This may trigger that the user device may obtain another at least one parameter set so that e.g. the method of the first aspect can be performed and/or controlled by the user device again, e.g. a plurality (e.g. at least two) of times, e.g. until the user device may obtain at least one parameter set that yielded in the comparing result of the first channel type information matching the second channel type information.

Else, based on the comparing and if the first channel type information matches the second channel type information, the user device may apply the quantization strategy information for a quantization of one or more signals (e.g. CIR/PDP signals as comprisable by a positioning report as disclosed above). Such a quantization may be performed and/or controlled by the user device of the first aspect. Such a quantization may be performed and/or controlled by the user device of the first aspect prior to a respective transmission of such signals. It will be understood that such an applying quantization strategy information may also be performed and/or controlled after the user device of the first aspect may have received a transmission (e.g. signal) to dequantize the received transmission, to name but one further non-limiting example.

Also, both steps of providing feedback information and applying the quantization strategy information may be performed and/or controlled, e.g. by the user device. For instance, this may be done if the comparing yields in the result that the at least one parameter set matches the second channel type information and thus, the feedback information may be indicative of or represent the match. Otherwise, the feedback information may be indicative of or represent such a mismatch between the first channel type information and the second channel type information. If such a mismatch is the result of the comparing, the apparatus of the first aspect (e.g. user device) may await for a provision of another at least one parameter set, e.g. from a network device (e.g. apparatus according to the second exemplary aspect).

According to an exemplary embodiment of all aspects, the feedback information indicates a mismatch (or a match). The feedback information may reflect a/the result of the comparing.

The network device (e.g. apparatus of the second aspect) may select a quantization strategy for a quantization of one or more signals, wherein the quantization strategy is selected based, at least in part, on a (e.g. anticipated, determined or obtained) (e.g. the) first channel type information. The network device further may determine the at least one parameter set based on the selected quantization strategy. The network device may provide (e.g. to the user device as disclosed above) the at least one parameter set.

This may allow to leverage one or more of the following channel's aspects in the user device (e.g. UE side), e.g. when configuring a CIR compression, clustering and/or quantization blocks for e.g. for a respective LPP positioning (e.g. DL positioning or UL positioning), at least one of:
sparsity in delay domain i.e. the CIR/PDP is typically composed (e.g. only) of a small number of non-negligible independent multipath components;
known spatial correlation across Rx antennas, e.g. as comprised by or connectable to the user device of the first aspect; or
known time coherence i.e. the CIRs/PDPs of two measurements performed within same coherence time are approximately equal (e.g. highly correlated).

The at least one parameter set may be part of a LPP, or more particularly, an enhanced LPP, e.g. as follows and/or as enabled by example embodiments of all exemplary aspects:
1. The network device (e.g. apparatus of the second aspect) may anticipate the channel profile of the user device (e.g. apparatus of the first aspect) e.g. urban, sub-urban, hilly terrain, indoor macro/micro, etc. This may be represented by the first channel type information.
2. The network device may select the CIR/PDP normalization strategy i.e. a linear or non-linear function f( ) used to normalize the estimated CIR. The function f( ) is used before the quantization step to map the CIR/PDP signals in a range that fits to the quantization properties.
3. The network device may select a quantization strategy (QS) e.g. scalar (SQ) vs vector quantization (VQ).
   a. For SQ:
      i. Type: uniform or non-uniform
      ii. Non-linear function g( ) for non-uniform scheme
   The network device may share the minimum and maximum range of scalar quantization, number of quantization levels (or equivalently, number of quantization bits).
   b. For VQ:

The network device may select a quantization codebook (QC) matching the expected channel profile. LMF also sets the dimensionality of the input to the VQ (shape of each codeword) across the time-spatial domains. The QC may be a set of indexed codewords obtained for each type of channel profile.

The QC specifies how consecutive CIR/PDP samples (in both Rx port and delay domain) may be quantized together.
4. The network device may transfer normalization function f( ) the QS parameters sets a) or b) and may indicate the channel type that the strategy is associated with. Such pieces of information may be comprised by the at least one parameter set.
5. The user device may receive QS and may assess whether the channel type indicated in step 3 matches with its own estimates (e.g. as represented or comprised by the second channel type information) e.g. either obtained from DL DMRS detection, synchronization (e.g. PSS and/or SSS synchronization) or other procedures.
6. If the two profiles (e.g. the first channel type information and the second channel type information) do not match, then user device may signal the mismatch to the network device (e.g. via the feedback information).
   a. The procedure may then be restarted in step 2.

According to an exemplary embodiment of all aspects, the at least one parameter set is an information element or at least a part of an information element.

The at least one parameter set may be a LTE positioning protocol, LPP, information element or at least a part (e.g. one or more fields) of such a LPP information element. Such one or more fields may for instance be a LocationInformation field, a Capabilities field, an AssistanceData field, or a combination thereof, to name but a few non-limiting examples. Such an information element may be part of the LPP, the parameter set. Such an information element may be part of a configuration, e.g. of the LPP, with which the user device may be configured with.

According to an exemplary embodiment of all aspects, the at least one parameter set comprises a respective parameter set per transmission and reception point, TRP.

The at least one parameter set may comprise such a respective parameter set per TRP, e.g. the at least one parameter set may comprise a plurality (e.g. at least two) of such parameter sets. A respective parameter set per TRP may comprise or be indicative of at least one of at least a respective quantization strategy information and the respective first channel type information. This may allow to apply different quantization strategy information for a communication of the user device specifically for a specific TRP, e.g. in a multi-TRP 5G mobile communication network.

According to an exemplary embodiment of the first aspect, the method further comprises:
measuring one or more channel impulse response signals; and
applying the quantization strategy information to the measured one or more channel impulse response signals within a deployed positioning session.

For instance, for providing a respective positioning report, the user device may include one or more channel impulse response signals in such a signal/transmission. The user device may measure the one or more channel impulse response signals and then apply the quantization strategy information to the measured one or more channel impulse response signals to quantize such signals.

According to an exemplary embodiment of the second aspect, if the feedback information is indicative of a match between the first channel type information of the at least one parameter set and a second channel type information as estimated by the user device, the method further comprises:
deploying a positioning session based, at least in part, on the at least one parameter set.

Additionally or alternatively, the measuring of the one or more channel impulse response signals and the applying of the quantization strategy information may be performed and/or controlled (e.g. by the user device) within a (e.g. LPP) positioning session (e.g. a DL positioning session). For this, e.g. between a respective user device and a respective network device, such a positioning session may be deployed (e.g. established).

According to an exemplary embodiment of the first aspect, the at least one parameter set is further indicative of a normalization strategy information, or the method further comprises:
determining the normalization strategy information based, at least in part, on the second channel type information and at least one of one or more measured channel impulse responses signals or one or more power delay profile signals; and
providing the normalization strategy information (e.g. as a part of the provided feedback information or together with the provided feedback information).

According to an exemplary embodiment of the second aspect, the method further comprises:
determining one or more quantizing cluster matrices based on at least one of one or more user device capabilities or user device expected channel types (e.g. channel profiles), wherein a respective quantizing cluster matrix of the one or more quantizing cluster matrices clusters one or more channel impulse response signals, and
wherein the at least one parameter set is further indicative of one or more quantizing cluster matrices

For instance, the user device may determine (e.g. decide) on a respective normalization function f( ). Further, the user device may determine (e.g. decide) on a VQ codebook (e.g. resulting in a (e.g. full) QC) for quantization of the one or more (e.g. CIR/PDP) signals. The user device may provide (e.g. send or share) at least the normalization function f( ) and QC with the network side, e.g. the network device of the second aspect. The pieces of information may be comprised by the normalization strategy information. The normalization strategy information may be in information element, in particular a LPP information element, or at least a part of such an information element or LPP information element. Upon receiving these pieces of information (e.g. as a part of a feedback information, to name but one non-limiting example), the network device may use this information for reconstructing the respective CIR/PDP (e.g. as previously measured by the user device and based on which the user device may have determined the normalization strategy information). Such information may be part of a configuration. Such a configuration may be conveyed (e.g. to the network device) as an index pointing to a class, where one or more classes may be defined as at least one of:
Class_1: f_1( ), VQ_1;
Class_2: f_2( ), VQ_2;
Class_3: f_3( ) VQ_3; or
Class_4: f_4( ), VQ_4;
and so on, to name but a few non-limiting examples.

In addition or in the alternative, the user device may determine e.g. that the CIR/PDP sample(s) can be clustered together (e.g. both) across one or more antenna ports, and a delay respective delay domain. Therefore, the user device may determine (e.g. define) quantizing cluster matrices. The user device may provide (e.g. inform) quantizing cluster matrices (e.g. to the network device). This may allow that the user device can inform the network device on that choice/on these choices.

The user device may determine if the at least one parameter set is further indicative of a normalization strategy information. If this is true, the network device may have performed and/or controlled the following:

According to an exemplary embodiment of the second aspect, the feedback information is further indicative of a normalization strategy information, wherein the method further comprises:
determining at least one of channel impulse response or a power delay profile for a channel used within a positioning session by a user device based on the normalization strategy information.

According to an exemplary embodiment of the first aspect, the method further comprises:
using the normalization strategy information to normalize one or more channel impulse response signals or one or more power delay profile signals (e.g. or more particularly, an estimated CIR).

The normalization may be performed and/or controlled before, or after the quantization (e.g. by applying the quantization strategy information) or as a part of the quantization. This may allow to map the one or more CIR/PDP signals in a range that may fit to (e.g. the) quantization properties (e.g. of a propagation channel that is used).

Further, the normalization may be applied within the deployed positioning session. This may allow to minimize the quantization loss of channel matrices associated with the channel profile(s) in a positioning session and allowing the user device to reduce overhead and latency by providing such quantized positioning reports comprising the normalized and/or quantized one or more CIR/PDP signals.

According to an exemplary embodiment of the first aspect, the at least one parameter set is further indicative of one or more quantizing cluster matrices, wherein a respective quantizing cluster matrix of the one or more quantizing cluster matrices clusters one or more channel impulse response signals across one or more antenna ports as comprised by or connectable to the apparatus of the first aspect, and wherein the normalization strategy information is further used to normalize the one or more quantizing cluster matrices.

For instance, the quantization strategy information comprises or represents at least one quantization cluster matrix (e.g. clustered across one or more antenna ports as comprised by the user device).

For instance, before obtaining the at least one parameter set, a respective network device (e.g. the network device from which the user device obtains the at least one parameter set) may determine (e.g. decide) a QS per TRP. For instance, the network device may determine (e.g. assert) that the respective CIR/PDP samples can be clustered together both across antenna ports, and delay: e.g., the network device may determine (e.g. define) and provide to the user device (e.g. inform the user device) one or more pieces of information about the respective quantizing cluster matrices, where a cluster matrix k may be defined as:

$$M ( k ) = [ \begin{matrix}c i {r}_{port 2} ( sample ( k - 1 ) L + 1 : kL + 1 ) \\ c i {r}_{port 1} ( sample ( k - 1 ) L + 1 : kL + 1 )\end{matrix} ] ,$$

where L is the cluster size in delay domain, e.g. L=10. It is noted that the network device (e.g. a LMF) may also request the user device (e.g. UE) to project the CIR/PDP onto a given basis prior to quantization. For this, the user device may obtain (e.g. receive) a corresponding request, e.g. from the network device.

According to an exemplary embodiment of the first aspect, the method further comprises:
mapping a respective quantizing cluster matrix of the one or more quantizing cluster matrices to a codeword of a quantization codebook.

According to an exemplary embodiment of the second aspect, the method further comprises:
selecting a quantization codebook, QC, based, at least in part, on an expected channel type (e.g. channel profile(s)) as represented by the first channel type information; and
providing the QC (e.g. to the apparatus of the first aspect).

Such a quantization codebook may be selected (e.g. by the network device). Such a quantization codebook may be selected in that the QC may match an expected channel profile, e.g. as represented by the first channel type information. This may allow to minimize the quantization loss of channel matrices. The(se) mapped codeword(s) may be utilized when sending positioning reference signals, PRS, to name but a few non-limiting examples.

Next, the user device may be tasked/instructed, e.g. by receiving a request, e.g. from the network device, e.g. for at least one of:
i. to normalize the channel matrix M(k) using a function f( ) determined by the LMF; or
ii. to map each matrix M(k), k=1: K to a codeword from the QC={Y(1), . . . , Y(N)}, where QC has been designed by the LMF to minimize the quantization loss of channel matrices associated with the channel profile identified in step B.

When a respective TRP is sending multiple PRS (e.g. beamformed PRSs), e.g. to the user device whose CIRs the user device may measure, then the matrix M(k) may cluster the respective (e.g. all) CIRs/PDPs extracted from PRS that have a common source/transmitter (collocated TX) and a common receiver (collocated RX), to name but a few non-limiting examples.

According to an exemplary embodiment of the first aspect, the second channel type information is estimated based on at least one of downlink, DL, demodulation reference signals, DMRS, detection, primary synchronization signal, PSS, synchronization, or measured (e.g. obtained or measured by the apparatus) channel properties. The second channel type information may represent a channel profile that is determined by the user device based, at least in part, on the user device's own observations.

According to an exemplary embodiment of the first aspect, the comparing further comprises determining whether or not the first channel type information matches the second channel type information. For such a comparing, the first channel type information and/or the second channel type information may comprise, among other things, datasets with different Line-of-Sight (LOS)/non Line-of-Sight (NLOS) rates. For instance, the first channel type information and/or the second channel type information may comprise the values (e.g. as fields in an information element, e.g. a LPP information element) of a Indoor Factory (InF) channel models and/or of Outdoor Factory (OuF) with different cluster density parameters, such as
InF/OuF-SL InF/OuF with Sparse clutter and Low base station height (e.g. both Tx and Rx are below the average height of the clutter);
InF/OuF-DL InF/OuF with Dense clutter and Low base station height (e.g. both Tx and Rx are below the average height of the clutter);
InF/OuF-SH InF/OuF with Sparse clutter and High base station height (e.g. Tx or Rx elevated above the clutter);
InF/OuF-DH InF/OuF with Dense clutter and High base station height (e.g. Tx or Rx elevated above the clutter); or
InF/OuF-HH InF/OuF with High Tx and High Rx (e.g. both elevated above the clutter).

Corresponding and afore mentioned channel models describing parameters may be represented by respective values, or by information being indicative of such values, to name but a few non-limiting examples.

According to an exemplary embodiment of all aspects, the quantization strategy information is associated with a specific channel type, and wherein the first channel type information represents the specific channel type.

According to an exemplary embodiment of the second aspect, the method further comprises:
selecting a normalization strategy information indicative of at least a normalization function to normalize at least one of one or more channel impulse response signals or one or more power delay profile signals (e.g. to map CIR/PSP signal(s) in a range that fits to quantization properties), wherein the normalization strategy is selected based on the first channel type information, and wherein the at least one parameter set is further indicative of the normalization strategy information.

The network device may select the CIR/PDP normalization strategy information e.g. to be indicative of or represent a linear or a non-linear function f( ) Such normalization function can then be used (e.g. by the user device) to normalize the estimated (by the user device) CIR. After the normalization strategy information is selected, the normalization strategy information may be comprised by the at least one parameter set that is provided e.g. to the user device. The normalization strategy information may be comprised in a field of an information element, e.g. of an LPP information element, e.g. the LPP information element as disclosed above that may represent the at least one parameter set.

According to an exemplary embodiment of the second aspect, the method further comprises:
determining or obtaining (e.g. retrieving from a storage) the first channel type information, and wherein the normalization strategy information is selected based, at least in part, on the determined or obtained first channel type information.

According to an exemplary embodiment of the second aspect, the method further comprises:
obtaining (e.g. receiving) feedback information; and
if the feedback information is indicative of a mismatch between the first channel type information of the at least one parameter set and a second channel type information as estimated by a user device, the apparatus performs and/or controls at least one further instance of the selecting of the quantization strategy, the determining of the at least one parameter set and the providing of the at least one parameter set based, at least in part, on the feedback information.

If the comparing, e.g. performed and/or controlled by the user device, yields in the result that the first channel type information mismatches the second channel type information, the user device may not be enabled to utilized the quantization strategy information for quantizing one or more signals e.g. to be comprised by a positioning report. Thus, the user device may require/request to be provided with a suitable at least one parameter set. Thus, the user device may provide feedback information allowing the network device to determine that an updated at least one parameter set is requested by the user device. This procedure may be repeated a plurality (e.g. at least two) of times until the first channel type information matches the second channel type information.

For instance, to avoid repetitive overhead, the feedback information may further be indicative of the respective channel type information (e.g. second channel type information) that the user device of the first aspect has determined/estimated/obtained. Additionally or alternatively, the network device of the second aspect may deny the (e.g. implicit) request by obtaining (e.g. receiving) the feedback information (e.g. of the user device) to change the quantization strategy information when a mismatch is observed at a z-th mismatch detection. The value z may be predefined. The value z may be set by the network device, and provided to the user device, e.g. as a part of a LPP configuration provided to the user device, to name but one non-limiting example.

When transferring the quantization strategy information to the user device, the network device may (e.g. also) inform the user device which channel type the strategy corresponds to. The user device may then verify if the channel type of the obtained at least one parameter set (e.g. represented by the first channel type information) matches the user device's observations (e.g. represented by second channel type information). In case of a mismatch, the user device may inform the network device about the mismatch, so that the network device may tune/update the QS (e.g. represented by the quantization strategy information) accordingly. As briefly mentioned above, to avoid a repetitive mismatch:
The user device may request the network device to derive QS for the channel type that the user device observes.
Alternatively, the network device may deny the user device's request to change the QS when a mismatch is observed at the z-th mismatch detection, where Z is set by the NW or the network device.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

In the figures show:

FIG. 1 a schematic block diagram of a system according to an exemplary aspect;

FIG. 2 a schematic example of CIR samples across multiple antenna ports, as used by example embodiments of all exemplary aspects;

FIG. 3 a signaling flowchart showing an example embodiment of a system according to all exemplary aspects;

FIG. 4 a flowchart showing an example embodiment of a method according to the first exemplary aspect;

FIG. 5 a flowchart showing an example embodiment of a method according to the second exemplary aspect; and

FIG. 6 a schematic block diagram of an apparatus configured to perform the method according to the first and/or second exemplary aspects.

### DETAILED DESCRIPTION OF SOME EXEMPLARY EMBODIMENTS

The following description serves to deepen the understanding and shall be understood to complement and be read together with the description as provided in the above summary section of this specification.

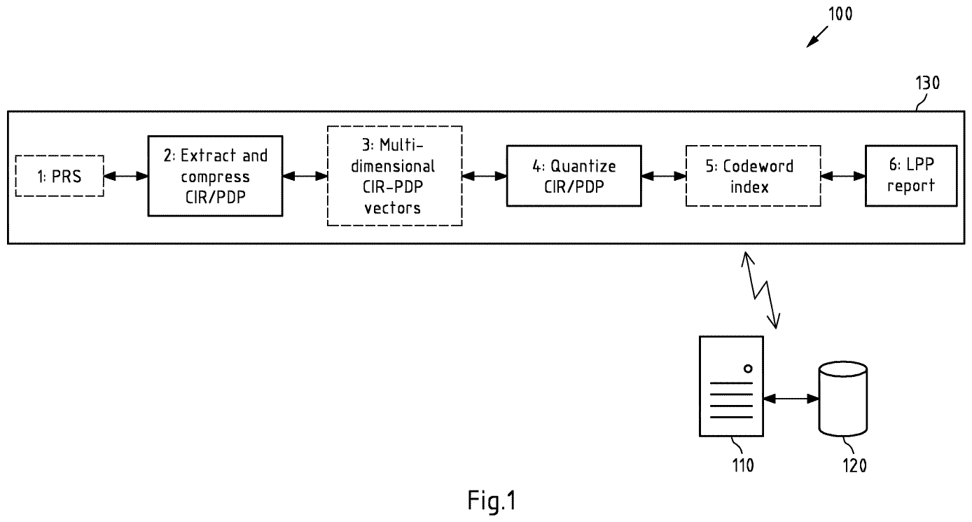

FIG. 1 is a schematic high-level block diagram of a system according to an exemplary aspect. The system 100 comprises a user device 130, and a LMF 110. Both entities, the user device 130, and the LMF 110 may be part of a mobile communication network (not shown). The LMF 110 may comprise or be connected to an optional database 120, e.g. for retrieving information such as a QC, first channel type information, or the like to name but a few non-limiting examples. The user device 130 and the LMF 110 may communicate with each other, as illustrated by the double arrow.

For transmitting one or more signals/data communications, the user device 130 may utilize the transmission chain, illustrated within the block 130 and comprising six blocks, wherein the blocks 1, 3 and 5 may be optional. When data/signals is/are transmitted by the user device 130, the chain may be passed in the order of the steps, e.g. from 1 to 5. When data/signal is/are received by the user device, the chain may be passed in an descending order of the steps, e.g. from 5 to 1, wherein in both cases, step 6 illustrates the normalized and quantized data/signals, here as an example the LPP (positioning) report.

The at least one parameter set as utilized by example embodiments of all aspects, e.g. in the form of a set of new information elements (IEs), e.g. for the LPP protocol, may enable the LMF 110 to jointly configure the:
CIR extraction/compression block 2, and
Quantization block 4
   in accordance with e.g.:
the user device 130 capabilities (e.g. sampling resolution, number of RF chains)
the predicted propagation channel characteristics (e.g. based on past PRS measurements (see block 1) and/or localization accuracies).

As an example, the LMF 110 selects the CIR/PDP normalization strategy and quantization strategy according to the channel state in user device 130 side and transfers a respective normalization function (e.g. represented by a respective normalization strategy information), the respective QS parameters sets (e.g. represented by a respective quantization strategy information), and indicates the respective channel type (e.g. represented by a respective first channel type information) and optionally (e.g. explicitly) with which the quantization strategy information is associated with to the user device 130. The user device 130 assesses whether the channel type indicated matches with its own estimates (e.g. as represented by a respective second channel type information) and signals the mismatch to the LMF 110.

The user device 130 may:
receive QS and assesses whether the channel type indicated matches with its own estimates e.g. either obtained from DL DMRS detection, PSS synchronization or other procedures; and
if the two profiles do not match, then UE signals the mismatch to the LMF.

The LMF 130 may:
select the CIR/PDP normalization strategy i.e. a linear or non-linear function f( ) used to normalize the estimated CIR. The function f( ) is used before the quantization step to map the CIR/PDP signals in a range that fits to the quantization properties;
select a quantization strategy (QS) e.g. scalar (SQ) vs vector quantization (VQ);
transfer normalization function, the QS parameters sets and indicates the channel type that the strategy is associated with (e.g. in the form of a respective at least one parameter set).

This may allow the user device 130 in particular to utilize block 4 for a functional module of ‘Compression and quantization’ on CIR/PDP to be used to provide the LMF 110 with a respective positioning report for position inference, so that data traffic over the NR air interface can be optimized, e.g. both from its size as all as its latency (e.g. due to the reduced size).

The at least one parameter set, e.g. in the form of a LPP information element, may allow the LMF 110 to transfer the normalization function, the QS parameters sets and indicates the channel type for/to the user device 130. A feedback information, e.g. also in the form of a LPP information element, may allow the user device 130 to signal a mismatch of channel type as provided by the LMF 110 to the user device 130. This procedure may be utilized by example embodiments of all exemplary aspects.

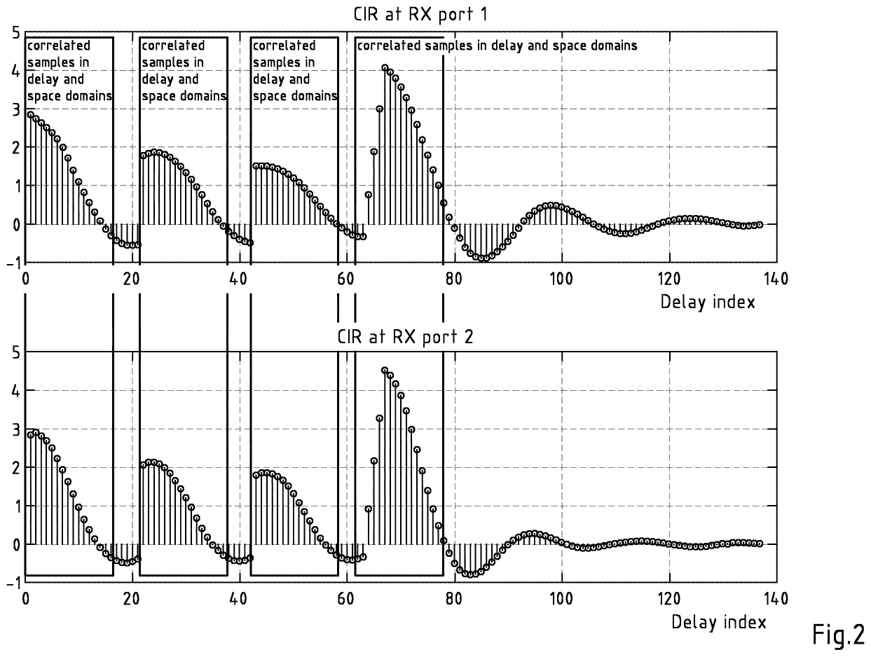

FIG. 2 shows a schematic example of CIR samples across multiple antenna ports, here at Rx port 1 and Rx port 2, e.g. of a user device 130 of FIG. 1, as used by example embodiments of all exemplary aspects.

Channel response vectors that the user device 130 may extract across its Rx antenna ports may exhibit at least one of:
spatial correlation (inversely proportional to the antenna separation); or
delay correlation as a result of imperfect bandpass, non-linearity added by the base station's (e.g. gNB of the mobile communication network) amplifier transmitter chain, filters and/or limited sampling resolution, i.e. one or more clusters of estimated taps in delay domain are highly correlated as they, in fact, may correspond to a single propagation path.

FIG. 2 shows an exemplary depiction of the above:
the true propagation channel consists of 4 dominant paths. This propagation channel is resolved by the user device into 4 clusters of taps (see 4 taps between delay indices 0 and 80) at each of the user device's 2 Rx antenna ports. The taps within such clusters are (e.g. heavily) corelated, as they have equal or similar respective CIRs. Similarly, the clusters are also correlated across Rx antenna ports.

In sum, the estimated CIR samples as shown at the two antenna ports Rx port 1 and Rx port 2 exhibit both intra- and inter-cluster correlation. It becomes thus apparent that a quantization strategy that exploits at least one of:
1. Property 1: the intra-inter-cluster correlation; or
2. Property 2: the cluster size in delay domain (e.g. the expected number of reflections and their separation in delay domain)
may be beneficial and allow to minimize both the quantization loss and the associated CIR reporting overhead.

Property 1 may be intrinsic to the user device (e.g. antenna separation, sampling rate, CIR estimator capability) and property 2 may be extrinsic to the user device (e.g. how far the clusters are separated in delay domain, the number of clusters). Therefore, prior to selecting the (e.g. best) quantization strategy (e.g. in the form of quantization strategy information), the LMF (e.g. apparatus of the second exemplary aspect, e.g. LMF 110 of FIG. 1) may need to learn or be informed about at least one of:
A. What the above user device capabilities are. Such a request may be resolved with existing LPP signaling, e.g. by adding a new LPP IE representing the at least one parameter set; or
B. What the expected channel profile (e.g. represented by a respective first channel type information) are. For instance, urban, sub-urban, indoor, etc. Such information may be obtained (e.g. retrieved or learned) from a serving gNB of the user device (e.g. target UE), or be based on a most recent LPP session outcome, etc. (as part of the current LPP initialization session), to name but a few non-limiting examples.

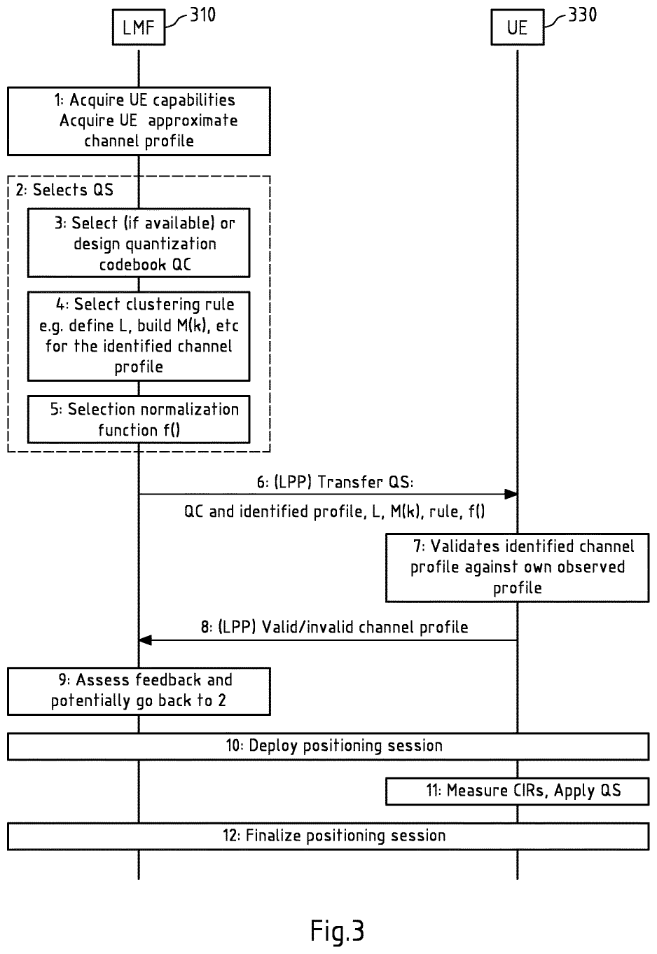

Now referring to FIG. 3 showing a signaling flowchart 300 showing an example embodiment of a system according to all exemplary aspects comprising a LMF 310 (e.g. apparatus according to the second exemplary aspect, e.g. LMF 110 of FIG. 1) and a UE 330 (e.g. apparatus according to the first exemplary aspect, e.g. user device 130 of FIG. 1), the LMF 310 may acquire the UE's 330 capabilities and acquire the UE's 330 approximate channel profile (e.g. represented by a respective first channel type information) in step 1.

Using the above information (i.e. UE's capabilities and channel profile), the LMF 310 may decide a QS per TRP, see step 2. Taking the use case shown in FIG. 2 as an example, the LMF 310 may assert that the CIR/PDP samples can be clustered together both across antenna ports, and delay: e.g., the LMF 310 may define and inform the UE 330 about the quantizing cluster matrices (see step/message 6). For this, the LMF 310 may in step 3 select (if available) or determine (e.g. design) a quantization codebook, QC. Further, the LMF 310 may in step 4 select a clustering rule, e.g. define L (e.g. cluster size in the delay domain), determine (e.g. build or generate) a respective or quantizing cluster matrix/matrices M(k) for the in step 1 acquired channel profile. Further, the LMF 310 may in step 5 select a respective normalization function f( ) These information may be part of an LPP information element and be represented by the at least one parameter set. The LMF 310 may transfer (e.g. send) the LPP information element in step/message 6 to the UE 330.

Next, the UE 330 may be tasked/instructed by the LMF 310:
i. to normalize the respective channel matrix using a function f( ) e.g. determined by the LMF 310; and
ii. to map each respective channel matrix to a codeword from a QC that has been designed by the LMF 310 to minimize the quantization loss of channel matrices associated with the channel profile identified in step ‘B’ above.

When transferring the QS strategy to the user device (see message 6 of FIG. 3), the LMF 310 may inform the UE 330 which channel type (e.g. by a respective first channel type information comprised by the at least one parameter set) the quantization strategy corresponds to. The UE 330 may then verify if the channel type matches UE's 330 observations, see step 7. In case of both a mismatch or a match, the UE 330 may inform the LMF 310 about it, see step/message 8 of the valid/invalid channel profile so that the LMF 310 tunes the QS accordingly (see step 9 of FIG. 3). At a minimum, the UE 330 may inform the LMF 310 of an invalid channel profile. The LMF 310 may assess the feedback information as received via message 8 and potentially go back go again through steps 2 ff in case of a mismatch.

Otherwise, the LMF 310 may deploy a positioning session between the LMF 310 and the UE 330, as illustrated by step 10). The UE 330 can in step 11 measure one or more CIRs and/or PDP signals, and apply the QS (e.g. in the form of the obtained quantization strategy information of step/message 6. In a step 12, the positioning session between the LMF 310 and the UE 330 can be finalized, e.g. resulting in the UE's 330 position being determined and the positioning session being ended, to name but a few non-limiting examples.

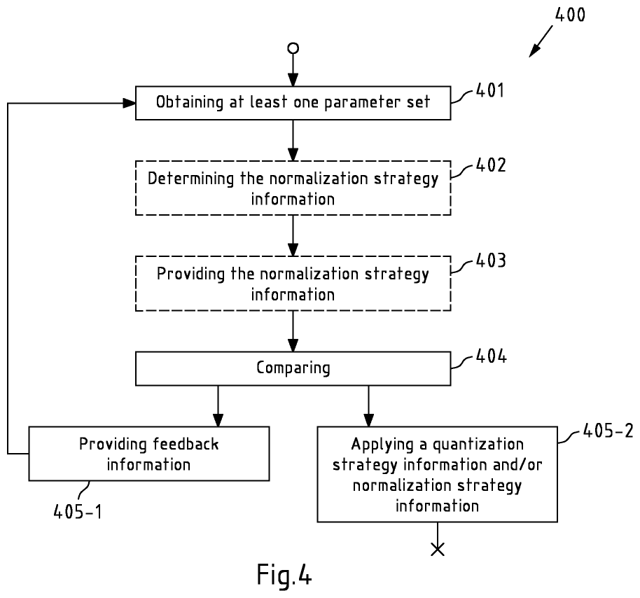

FIG. 4 is a flowchart 400 showing an example embodiment of a method according to the first exemplary aspect. This flowchart 400 may for instance be performed by a user device, e.g. user device 130 of FIG. 1.

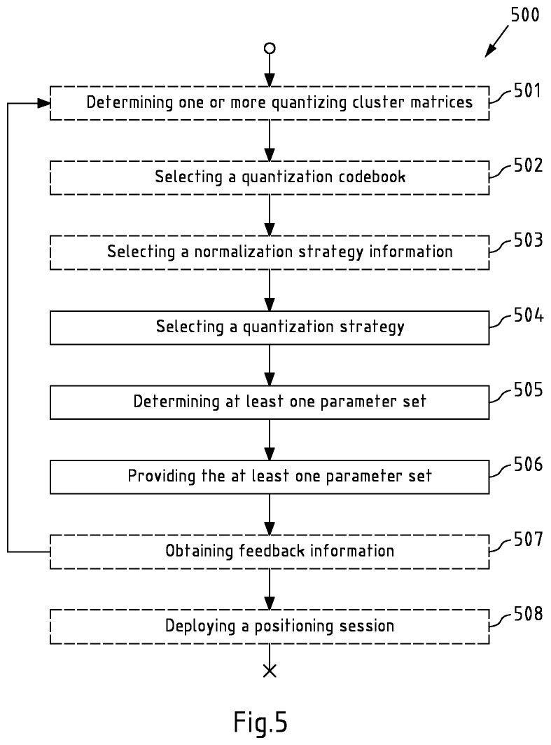

In a first step 401, at least one parameter set is obtained. The at least one parameter set may be obtained by receiving the at least one parameter set from a network device (e.g. LMF 110 of FIG. 1). Such a network device may for instance perform and/or control the flowchart 500 of FIG. 5.

In an optional second step 402, for instance in case the at least one parameter set of step 401 does not comprise or is not indicative of a normalization strategy information, the apparatus performing and/or controlling the flowchart 400 may determine the normalization strategy information.

In another optional step 403, for instance in case step 402 has been performed and/or controlled, the determined normalization strategy information is provided, e.g. to the respective network device from which the apparatus performing and/or controlling the flowchart 400 has obtained in step 401 the at least one parameter set.

In a fourth step 404, a comparing is done. For instance, the at least one parameter set obtained in step 401 comprises or is indicative of a respective first channel type information. The apparatus performing and/or controlling the flowchart 400 may determine a second channel type information with which the apparatus then compares the first channel type information.

Based on the comparing, and the first channel type information mismatches (e.g. is not equal or similar to) the second channel type information, the flowchart 400 may continue with step 405-1. The apparatus performing and/or controlling the flowchart 400 determines a feedback information indicative of the mismatch. The feedback information is provided, e.g. by sending the feedback information to the apparatus from which the at least one parameter set was obtained in step 401. Since the apparatus performing and/or controlling the flowchart 400 awaits a suitable at least one parameter set that enables the apparatus to apply the quantization strategy information, e.g. in order to minimize overhead and latency in (a) 5G (NR) positioning session(s), the flowchart 400 may be repeated by starting again at step 401 so that another at least one parameter set is obtained.

Based on the comparing, and the first channel type information matches (e.g. is equal or similar to) the second channel type information, the flowchart 400 may continue with step 405-2. In the step 405-2, a quantization strategy information and/or normalization strategy information is applied, e.g. to a respective positioning report or to one or more signals to be comprised by such a respective positioning report after the quantization strategy and/or normalization strategy has been applied to them. In this way, overhead and latency in (a) respective 5G (NR) positioning session(s) is minimized.

FIG. 5 is a flowchart 500 showing an example embodiment of a method according to the second exemplary aspect. This flowchart 500 may for instance be performed by a user device, e.g. network device, e.g. LMF 130 of FIG. 1. The flowchart 500 may be performed by a system comprising the apparatus performing and/or controlling the flowchart 500, and a user device (e.g. user device 130 of FIG. 1) performing and/or controlling the flowchart 400 of FIG. 4.

In an optional first step 501, one or more quantizing cluster matrices are determined. For this, the apparatus performing and/or controlling the flowchart 500 may obtain (e.g. acquire) one or more of capabilities of a respective user device (e.g. user device 130 of FIG. 1), and/or an expected channel profile (e.g. represented by a respective first channel type information). Such information may for instance be retrieved from a storage or memory, e.g. the database 120 of FIG. 1. Such a database may be held available in one or more entities of a respective mobile communication network, for instance a 5G (NR) mobile communication network.

In an optional second step 502, a quantization codebook is selected, e.g. one or more of such quantization codebooks may be held available in the mentioned storage or memory, e.g. the database 120 of FIG. 1. The quantization codebook may be selected based, at least in part, on the first channel type information, for instance, there may be certain quantization codebook predefined that may be a suitable choice dependent on the first channel type information respectively which channel model such a respective first channel type information may represent.

In an optional third step 503, a normalization strategy information is selected. Again, such pieces of different normalization strategy information may be held available in a storage or memory (e.g. the database 120 of FIG. 1), and such normalization strategy information may be predefined in that they may be a suitable choice, e.g. for past occurrences, to name but one non-limiting example.

In a fourth step 504, a quantization strategy is selected, e.g. based, at least in part, on the first channel type information and in particular as disclosed in detail in above summary and detailed description sections of this specification.

In a fifth step 505, at least one parameter set is determined. The at least one parameter set may be indicative of or comprise at least one of the information utilized and/or selected in the previous steps 501 to 504.

In a sixth step 506, the determined at least one parameter set of step 505 is provided, e.g. by sending the at least one parameter set, e.g. to the user device which capabilities may have been acquired in conjunction with step 501.

In an optional seventh step 507, a feedback information is obtained, e.g. by receiving the feedback information, e.g. from the user device to which the at least one parameter set was provided in the step 506. The feedback information may be indicative of or represent that the provided at least one parameter step was not suitable for the recipient (e.g. the user device) to quantize signals, e.g. for a respective positioning report. In this case, the flowchart may continue with step 501 (or at least step 504) to determine an updated at least one parameter set that may be suitable. Also, the feedback information obtained (e.g. received) in step 507 may be indicative of or represent that the provided at least one parameter set of step 506 was suitable for the recipient. In this case, the flowchart may continue with step 508 and the apparatus performing and/or controlling the flowchart 500 may deploy a positioning session, e.g. with the user device to which the at least one parameter set was provided in step 506. Also, the step 507 may be skipped after step 506 has been performed and/or controlled, and still the optional step 508 is performed and/or controlled.

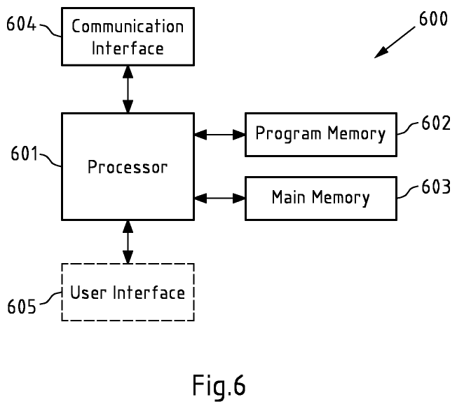

FIG. 6 is a schematic block diagram of an apparatus 600 according to the first and/or second exemplary aspect, which may for instance represent the user device 130 of FIG. 1. Alternatively, the schematic block diagram of FIG. 6 may represent the LMF 110 of FIG. 1 in which case the apparatus 600 is an apparatus according to the second exemplary aspect.

Apparatus 600 comprises a processor 601, working or main memory 603, program memory 602, data memory (not shown), communication interface(s) 604, an optional user interface 605 and optional sensor(s) (not shown).

Apparatus 600 may for instance be configured to perform and/or control or comprise respective means (at least one of 601 to 605) for performing and/or controlling the method according to the first and/or second exemplary aspects. Apparatus 600 may as well constitute an apparatus comprising at least one processor (601) and at least one memory (603) including instructions (for example, computer program code) that when executed by the at least one processor, cause an apparatus, e.g. apparatus 600 at least to perform and/or control the method according first and/or second exemplary aspects.

Processor 601 may for instance comprise a determiner as a functional and/or structural unit. Determiner may for instance be configured to determine a normalization strategy information (see step 402 of FIG. 4), and/or a quantization strategy information (see step 504 of FIG. 5) and/or a respective quantizing cluster matrix (see step 501 of FIG. 5) and/or at least one parameter set (see step 506 of FIG. 5. Processor 601 may for instance comprise a comparer as a functional and/or structural unit. Comparer may for instance be configured to compare a respective first channel type information to a second channel type information (see step 404 of FIG. 4). Processor 601 may for instance comprise an applyer as a functional and/or structural unit. Applyer may for instance be configured to apply a respective normalization strategy information and/or a respective quantization strategy information (see step 405-2 of FIG. 4). Processor 601 may for instance comprise a selector as a functional and/or structural unit. Selector may for instance be configured to select a respective quantization codebook (see step 502 of FIG. 5) and/or a normalization strategy information (see step 503 of FIG. 5) and/or a quantization strategy (see step 504 of FIG. 5). Processor 601 may for instance comprise a deployer as a functional and/or structural unit. Deployer may for instance be configured to deploy an UL and/or a DL positioning session (see step 508 of FIG. 5).

Processor 601 may for instance further control the memories 603, the communication interface(s) 604, the optional user interface 605 and the optional sensor(s).

Processor 601 may for instance execute computer program code stored in program memory 602, which may for instance represent a computer readable storage medium comprising program code that, when executed by processor 601, causes the processor 601 to perform the method according to the first and/or second exemplary aspects.

Processor 601 (and also any other processor mentioned in this specification) may be a processor of any suitable type. Processor 601 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware has been programmed in such a way to carry out the described function. Processor 601 may for instance be an application processor that runs an operating system.

Program memory 602 may also be included into processor 601. This memory may for instance be fixedly connected to processor 601, or be at least partially removable from processor 601, for instance in the form of a memory card or stick. Program memory 602 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 602 may also comprise an operating system for processor 601. Program memory 602 may also comprise a firmware for apparatus 600.

Apparatus 600 comprises a working memory 603, for instance in the form of a volatile memory. It may for instance be a Random Access Memory (RAM) or Dynamic RAM (DRAM), to give but a few non-limiting examples. It may for instance be used by processor 601 when executing an operating system and/or computer program.

Data memory may for instance be a non-volatile memory. It may for instance be a FLASH memory (or a part thereof), any of a ROM, PROM, EPROM and EEPROM memory (or a part thereof) or a hard disc (or a part thereof), to name but a few examples. Data memory may for instance store one or more pieces of parameter sets, one or more pieces of normalization strategy information, one or more pieces of quantization strategy information, one or more pieces of first channel type information, one or more pieces of second channel type information, one or more pieces of quantization channel matrices, or a combination thereof, to name but a few non-limiting examples.

Communication interface(s) 604 enable apparatus 600 to communicate with other entities, e.g. with LMF 110 of FIG. 1 in case apparatus 600 represents a user device (e.g. user device 130 of FIG. 1). In this case apparatus 600 may also communicate with other user devices that may represent also apparatuses of the first exemplary aspect. Communication interface(s) 604 enable apparatus 600 to communicate with other entities, e.g. with user device 130 of FIG. 1 in case apparatus 600 represents a network device (e.g. LMF 110 of FIG. 1). The communication interface(s) 604 may for instance comprise a wireless interface, e.g. a cellular radio communication interface and/or a WLAN interface) and/or wire-bound interface, e.g. an IP-based interface, for instance to communicate with entities via the Internet.

User interface 605 is optional and may comprise a display for displaying information to a user and/or an input device (e.g. a keyboard, keypad, touchpad, mouse, etc.) for receiving information from a user.

Sensor(s) are optional and may for instance comprise a barometric sensor, and accelerometer, a GNSS (e.g. GPS) sensor, to name but a few non-limiting examples.

Some or all of the components of the apparatus 600 may for instance be connected via a bus. Some or all of the components of the apparatus 600 may for instance be combined into one or more modules.

According to an example aspect, there is provided an apparatus (such as user device describe above) configured to perform operations comprising: obtaining (e.g. receiving) at least one parameter set indicative of at least a quantization strategy information and a first channel type information, wherein the at least one parameter set is an LTE positioning protocol, LPP, information element or at least a part of a LPP information element. By receiving this information in LPP, the apparatus may further perform any embodiments described herein. For example, the apparatus may process and/or apply the received information. For example, the received information (e.g. quantization strategy information and first channel type information) may be applied as described herein.

The following embodiments shall also be considered to be disclosed:

### Embodiment 1

A method, e.g. performed and/or controlled by at least one apparatus, the method comprising:
obtaining at least one parameter set indicative of at least a quantization strategy information and a first channel type information;
comparing the first channel type information with a second channel type information; and
based on the comparing and if the first channel type information mismatches the second channel type information, providing feedback information, or
based on the comparing and if the first channel type information matches the second channel type information, applying the quantization strategy information for a quantization of one or more signals.

### Embodiment 2

The method according to embodiment 1, wherein the at least one parameter set is an LTE positioning protocol, LPP, information element or at least a part of a LPP information element.

### Embodiment 3

The method according to embodiment 1 or embodiment 2, wherein the at least one parameter set comprises a respective parameter set per transmission and reception point, TRP.

### Embodiment 4

The method according to any of the preceding embodiments, further comprising:
measuring one or more channel impulse response signals; and
applying the quantization strategy information to the measured one or more channel impulse response signals within a deployed positioning session.

### Embodiment 5

The method according to any of the preceding embodiments, wherein the at least one parameter set is further indicative of a normalization strategy information, or the method further comprises:
determining the normalization strategy information based, at least in part, on the second channel type information and at least one of one or more measured channel impulse responses signals or one or more power delay profile signals; and
providing the normalization strategy information.

### Embodiment 6

The method according to any of the preceding embodiments, further comprising:
using the normalization strategy information to normalize one or more channel impulse response signals or one or more power delay profile signals.

### Embodiment 7

The method according to any of the preceding embodiments, wherein the at least one parameter set is further indicative of one or more quantizing cluster matrices, wherein a respective quantizing cluster matrix of the one or more quantizing cluster matrices clusters one or more channel impulse response signals across one or more antenna ports (e.g. as comprised by or connectable to an apparatus performing and/or controlling the method), and
wherein the normalization strategy information is further used to normalize the one or more quantizing cluster matrices.

### Embodiment 8

The method according to any of the preceding embodiments, further comprising:
mapping a respective quantizing cluster matrix of the one or more quantizing cluster matrices to a codeword of a quantization codebook.

### Embodiment 9

The method according to any of the preceding embodiments, wherein the second channel type information is estimated based on at least one of downlink, DL, demodulation reference signals, DMRS, detection, synchronization, or measured channel properties.

### Embodiment 10

The method according to any of the preceding embodiments, wherein the feedback information indicates a mismatch as a result of the comparing.

### Embodiment 1

The method according to any of the preceding embodiments, wherein the quantization strategy information is associated with a specific channel type, and wherein the first channel type information represents the specific channel type.

### Embodiment 12

A method, e.g. performed and/or controlled by at least one apparatus (e.g. different from the apparatus of embodiment 1), the method comprising:
selecting a quantization strategy for a quantization of one or more signals, wherein the quantization strategy is selected based, at least in part, on a first channel type information;
determining at least one parameter set indicative of at least quantization strategy information and the first channel type information based on the selected quantization strategy; and
providing the at least one parameter set.

### Embodiment 13

The method according to embodiment 12, further comprising:
selecting a normalization strategy information indicative of at least a normalization function to normalize at least one of one or more channel impulse response signals or one or more power delay profile signals, wherein the normalization strategy is selected based on the first channel type information,
and wherein the at least one parameter set is further indicative of the normalization strategy information.

### Embodiment 14

The method according to embodiment 12 or embodiment 13, wherein the at least one parameter set comprises a respective parameter set per transmission and reception point, TRP.

### Embodiment 15

The method according to any of the embodiments 12 to 14, further comprising:
obtaining feedback information; and
if the feedback information is indicative of a mismatch between the first channel type information of the at least one parameter set and a second channel type information as estimated by a user device, performing and/or controlling at least one further instance of the selecting of the quantization strategy, the determining of the at least one parameter set and the providing of the at least one parameter set based, at least in part, on the feedback information (see steps of embodiment 12).

### Embodiment 16

The method according to any of the embodiments 12 to 15, if the feedback information is indicative of a match between the first channel type information of the at least one parameter set and a second channel type information as estimated by the user device, the method further comprises:
deploying a positioning session based, at least in part, on the at least one parameter set.

### Embodiment 17

The method according to any of the embodiments 12 to 16, wherein the feedback information is further indicative of a normalization strategy information, wherein the method further comprises:
determining at least one of channel impulse response or a power delay profile for a channel used within a positioning session by a user device based on the normalization strategy information.

### Embodiment 18

The method according to any of the embodiments 12 to 17, further comprising:
determining one or more quantizing cluster matrices based on at least one of one or more user device capabilities or user device expected channel types, wherein a respective quantizing cluster matrix of the one or more quantizing cluster matrices clusters one or more channel impulse response signals, and wherein the at least one parameter set is further indicative of one or more quantizing cluster matrices

### Embodiment 19

The method according to any of the embodiments 12 to 18, further comprising:
selecting a quantization codebook, QC, based, at least in part, on an expected channel type as represented by the first channel type information; and
providing the QC.

### Embodiment 20

The method according to any of the embodiments 12 to 19, wherein the at least one parameter set is a LTE positioning protocol, LPP, information element or at least a part of a LPP information element.

### Embodiment 21

The method according to any of the embodiments 12 to 20, wherein the quantization strategy information is associated with a specific channel type, and wherein the first channel type information represents the specific channel type.

### Embodiment 22

An apparatus comprising at least one processor and at least one memory storing instructions that, when executed by the at least one processor, cause an apparatus at least to perform and/or control the method according any of embodiments 1 to 11.

### Embodiment 23

An apparatus comprising respective means for performing the method of any of embodiments 1 to 11.

### Embodiment 24

An apparatus comprising at least one processor and at least one memory storing instructions that, when executed by the at least one processor, cause an apparatus at least to perform and/or control the method according any of embodiments 12 to 21.

### Embodiment 25

An apparatus comprising respective means for performing the method of any of embodiments 12 to 21.

### Embodiment 26

A system comprising:
at least one apparatus according to embodiment 22 or 23; and
at least one apparatus according to embodiment 24 or 25.

### Embodiment 27

A computer program comprising instructions, which, when executed by an apparatus, cause the apparatus to:
obtaining at least one parameter set indicative of at least a quantization strategy information and a first channel type information;
comparing the first channel type information with a second channel type information; and
based on the comparing and if the first channel type information mismatches the second channel type information, providing feedback information, or
based on the comparing and if the first channel type information matches the second channel type information, applying the quantization strategy information for a quantization of one or more signals.

### Embodiment 28

The computer program of embodiment 27, further comprising instructions, which, when executed by an apparatus, cause the apparatus to perform the method of any of embodiments 2 to 11.

### Embodiment 29

A computer program comprising instructions, which, when executed by an apparatus, cause the apparatus to:
selecting a quantization strategy for a quantization of one or more signals, wherein the quantization strategy is selected based, at least in part, on a first channel type information;
determining at least one parameter set indicative of at least quantization strategy information and the first channel type information based on the selected quantization strategy; and
providing the at least one parameter set.

### Embodiment 30

The computer program of embodiment 29, further comprising instructions, which, when executed by an apparatus, cause the apparatus to perform the method of any of embodiments 13 to 21.

### Embodiment 31

A computer program product (e.g. a computer storage medium, such as a non-transitory computer readable medium) comprising a computer program of embodiment 27 or embodiment 28.

### Embodiment 32

A computer program product (e.g. a computer storage medium, such as a non-transitory computer readable medium) comprising a computer program of embodiment 29 or embodiment 30.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Having the same meaning as the expression “A and/or B”, the expression “at least one of A or B” may be used herein. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A.

It will be understood that all presented embodiments are only exemplary, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the figures shall be considered as one possible sequence of method steps for the respective embodiment described by the respective figure.

The subject-matter has been described above by means of example embodiments. It should be noted that there are alternative ways and variations which are obvious to a skilled person in the art and can be implemented without deviating from the scope of the appended claims.

1. An apparatus comprising:
means for obtaining at least one parameter set indicative of at least a quantization strategy information and a first channel type information;
means for comparing the first channel type information with a second channel type information obtained by the apparatus; and
means for, based on the comparing and if the first channel type information mismatches the second channel type information, providing feedback information, or
means for, based on the comparing and if the first channel type information matches the second channel type information, applying the quantization strategy information for a quantization of one or more signals.

2. The apparatus according to claim 1, wherein the at least one parameter set is an LTE positioning protocol, LPP, information element or at least a part of a LPP information element.

3. The apparatus according to claim 1 or claim 2, wherein the at least one parameter set comprises a respective parameter set per transmission and reception point, TRP.

4. The apparatus according to claim 1 or claim 2, further comprising:
means for measuring one or more channel impulse response signals; and
means for applying the quantization strategy information to the measured one or more channel impulse response signals within a deployed positioning session.

5. The apparatus according to any of the preceding claims, wherein the at least one parameter set is further indicative of a normalization strategy information, or the apparatus further comprises:
means for determining the normalization strategy information based, at least in part, on the second channel type information and at least one of one or more measured channel impulse responses signals or one or more power delay profile signals; and
means for providing the normalization strategy information.

6. The apparatus according to claim 5, further comprising:
means for using the normalization strategy information to normalize one or more channel impulse response signals or one or more power delay profile signals.

7. The apparatus according claim 5 or claim 6, wherein the at least one parameter set is further indicative of one or more quantizing cluster matrices, wherein a respective quantizing cluster matrix of the one or more quantizing cluster matrices clusters one or more channel impulse response signals across one or more antenna ports as comprised by or connectable to the apparatus, and
wherein the normalization strategy information is further used to normalize the one or more quantizing cluster matrices.

8. The apparatus according to claim 7, further comprising:
means for mapping a respective quantizing cluster matrix of the one or more quantizing cluster matrices to a codeword of a quantization codebook.

9. The apparatus according to any of the preceding claims, wherein the second channel type information is estimated based on at least one of downlink, DL, demodulation reference signals, DMRS, detection, primary synchronization signal, PSS, synchronization, or measured channel properties.

10. The apparatus according to any of the preceding claims, wherein the feedback information indicates a mismatch as a result of the comparing.

11. The apparatus according to any of the preceding claims, wherein the quantization strategy information is associated with a specific channel type, and wherein the first channel type information represents the specific channel type.

12. An apparatus comprising:
means for selecting a quantization strategy for a quantization of one or more signals, wherein the quantization strategy is selected based, at least in part, on a first channel type information;
means for determining at least one parameter set indicative of at least quantization strategy-information and the first channel type information based on the selected quantization strategy; and
means for providing the at least one parameter set.

13. The apparatus according to claim 12, further comprising:
means for selecting a normalization strategy information indicative of at least a normalization function to normalize at least one of one or more channel impulse response signals or one or more power delay profile signals, wherein the normalization strategy is selected based on the first channel type information,
and wherein the at least one parameter set is further indicative of the normalization strategy information.

14. The apparatus according to claim 13, further comprising:
means for obtaining feedback information; and
if the feedback information is indicative of a mismatch between the first channel type information of the at least one parameter set and a second channel type information as estimated by a user device, the apparatus performs and/or controls at least one further instance of the selecting of the quantization strategy, the determining of the at least one parameter set and the providing of the at least one parameter set based, at least in part, on the feedback information.

15. The apparatus according to claim 14, if the feedback information is indicative of a match between the first channel type information of the at least one parameter set and a second channel type information as estimated by the user device, the apparatus further comprising:
means for deploying a positioning session based, at least in part, on the at least one parameter set.

16. The apparatus according to claim 14 or claim 15, wherein the feedback information is further indicative of a normalization strategy information, wherein the apparatus further comprises:
means for determining at least one of channel impulse response or a power delay profile for a channel used within a positioning session by a user device based on the normalization strategy information.

17. The apparatus according to any of the claims 12 to 16, further comprising:
means for determining one or more quantizing cluster matrices based on at least one of one or more user device capabilities or user device expected channel types, wherein a respective quantizing cluster matrix of the one or more quantizing cluster matrices clusters one or more channel impulse response signals, and
wherein the at least one parameter set is further indicative of one or more quantizing cluster matrices

18. The apparatus according to any of the claims 12 to 17, further comprising:
means for selecting a quantization codebook, QC, based, at least in part, on an expected channel type as represented by the first channel type information; and
providing the QC.
